(19) United States
(12) Patent Application Publication
(10) Pub. No.: US 2003/0125921 A1
(43) Pub. Date: Jul. 3, 2003

(54) Circuit simulation apparatus, circuit simulation method, circuit simulation program, and storage medium storing circuit simulation program

(75) Inventor: Akira Yamamoto, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/322,534

(22) Filed: Dec. 19, 2002

(30) Foreign Application Priority Data
Dec. 27, 2001 (JP) 2001-396830

(51) Int. Cl. G06F 17/50

(52) U.S. Cl. 703/16

(57) ABSTRACT

An analog circuit simulator simulates an operation of an analog circuit based on analog circuit configuration information and signal information indicating a signal input to the analog circuit. A digital circuit simulator simulates an operation of a digital circuit based on digital circuit configuration information and signal information indicating a signal input to the digital circuit. A control section controls executing timing of the simulations performed by the simulators. It allows the analog circuit simulator to simulate the operation for each predetermined cycle time Δt while it allows the digital circuit simulator to simulate the operation of the digital circuit according to the change of the level of a clock signal or the like that is input to the digital circuit. The speed of simulation for analog-digital hybrid circuits is improved.

### BACKGROUND OF THE INVENTION

The present invention relates to circuit simulation technologies for performing simulations of operations in analog-digital hybrid circuits having analog circuits and digital circuits.

In recent years, the degree of integration of LSIs has been increasing year after year, as LSI designing and manufacturing technologies improve. In the past, circuits having different functions were packaged in different semiconductor chips, but the trend is to incorporate the whole system having different functions into a single chip. This trend is shared by circuits having analog circuits and digital circuits, and it has become increasingly common that an analog circuit portion and a digital circuit portion are incorporated in a single semiconductor chip. Consequently, the simulation of operations in analog-digital hybrid circuits has become an essential technology.

The simulation of operations in the hybrid circuits as described above is conventionally carried out using a circuit simulation apparatus. The conventional circuit simulation apparatus typically comprises an analog circuit simulator and a digital circuit simulator, and carries out the simulation by associating the state of an analog circuit and that of a digital circuit at each predetermined cycle time.

When the simulation for the analog circuit and the simulation for the digital circuit are performed independently of each other, the cycle time for a simulation is generally set longer for the digital circuits than for the analog circuits. The reason is as follows. The state of the digital circuit remains in a constant state during a period from a certain change of a state to the next change of the state in synchronization with, for example, a clock signal, whereas the state of the analog circuit (i.e., signal levels of various portions thereof) changes as time elapses little by little. Therefore, it is only necessary for a simulation for the digital circuit to perform the simulation with a cycle time that is synchronized with the clock signal or the like.

More specifically, assuming that the cycle time necessary for the simulation for the analog circuit is 0.1 ns and that for the digital circuit is 1.0 ns, it is sufficient that on average, the simulation for the digital circuit be carried out once during the period in which the simulation for the analog circuit is carried out ten times.

In practice, however, the proportion between the simulation for the analog circuit and the simulation for the digital circuit may not be constant when, for example, the frequency of the clock signal in the digital circuit changes. Moreover, when a simulation for an analog-digital hybrid circuit is performed, a problem arises in the timing at which a simulation for the digital circuit is to be performed, because it is necessary to associate the simulations for both types of circuits. Specifically, when the digital circuit receives an output from the analog circuit, the output from the digital circuit must be determined according to the timing corresponding to the cycle time for the analog circuit. More specifically, in the case of, for example, a timing recovery loop circuit that generates a clock signal based on a reproduced signal read out from an optical disk and the case of a digital circuit that operates based on the generated clock signal the frequency and phase of the clock signal itself change according to the timing that corresponds to the cycle time for the analog circuit, and consequently, the output from the digital circuit also must be changed according to the foregoing timing.

For these reasons, the conventional circuit simulation apparatus has been configured to perform the simulation for the analog circuit and that for the digital circuit at the same cycle time.

Because the conventional circuit simulation apparatus carries out the simulation for analog circuit and the simulation for digital circuit at the same cycle time, it has a problem in that the simulation speed cannot be increased easily. More specifically, if the cycle time is shortened to increase the precision in the simulation for the analog circuit, the number of times the simulation for the digital circuit is performed accordingly becomes larger, thereby increasing the time necessary for the entire simulation.

### SUMMARY OF THE INVENTION

In view of the foregoing and other problems, it is an object of the invention to easily achieve an increase in the speed of simulation for analog-digital hybrid circuits without degrading the simulation accuracy for analog circuits.

This and other objects are accomplished in accordance with a first aspect of the present invention by providing a circuit simulation apparatus for simulating an operation of an analog-digital hybrid circuit having an analog circuit and a digital circuit, comprising: an analog circuit-simulating means for performing a simulation for the analog circuit; a digital circuit-simulating means for performing a simulation for the digital circuit; and a control means for controlling timing of executing the circuit simulation performed by the digital circuit-simulating means according to change of the level of at least one of a predetermined signal that is input to the analog circuit and a predetermined signal that is input to the digital circuit.

According to a second aspect of the invention, in the circuit simulation apparatus according to the first aspect, the predetermined signal comprises a clock signal.

According to a third aspect of the invention, in the circuit simulation apparatus according to the first aspect, the predetermined signal comprises a signal that changes, at timing corresponding to the change of the signal level of the signal, the level of a signal which is output from the digital circuit.

According to a fourth aspect of the invention, in the circuit simulation apparatus according to the first aspect, the predetermined signal comprises at least one of a signal that controls a state-holding circuit in the digital circuit and a signal that changes the signal that controls a state-holding circuit in the digital circuit.

According to a fifth aspect of the invention, in the circuit simulation apparatus according to the first aspect, the predetermined signal comprises a signal such that the digital circuit operates differently according to the sequence between change timing of the level of the signal and change timing of the level of another signal.

According to the above-described aspects of the invention, the timing of executing the simulation for the digital circuit is controlled according to the change in the level of the input signal that influences the changes of the levels of output signals from the digital circuit and internal signals (the internal states that are held inside). This makes it possible to considerably reduce the amount of computation required for the simulation for the digital circuit and thereby to increase the speed of the simulation for the analog-digital hybrid circuit. Moreover, appropriate simulation results can be easily obtained.

According to a sixth aspect of the invention, in the circuit simulation apparatus according to the first aspect, the predetermined signal is designated in advance of the simulation.

According to a seventh aspect of the invention, the circuit simulation apparatus according to the first aspect further comprises a detecting means for detecting at least one of the predetermined signal that is input to the analog circuit and the predetermined signal that is input to the digital circuit; wherein the control means controls the circuit simulation so that the circuit simulation performed by the digital circuit simulation means is executed when the predetermined signal level detected by the detecting means changes.

According to an eighth aspect of the invention, in the circuit simulation apparatus according to the seventh aspect, the detecting means detects the predetermined signal based on attribute information of at least one of a signal input to the analog circuit and a signal input to the digital circuit, the signals being supplied to at least one of the analog circuit-simulating means and the digital circuit simulating means.

According to a ninth aspect of the invention, in the circuit simulation apparatus according to the seventh aspect, the detecting means detects the predetermined signal by analyzing circuit configuration information representing the digital circuit, the circuit configuration information being given to the digital circuit-simulating means.

According to these aspects of the invention, the input signal that influences the output from the digital circuit and the internal state thereof, that is, an input signal that needs to be monitored to control the execution timing of the digital circuit simulation, is designated by an operator or the like, or is detected based on the circuit configuration information or the like, and the level of the designated or detected signal is monitored. Thus, the number of signals that are to be monitored can be reduced, and the simulation can be performed at even higher speeds.

According to a tenth aspect of the invention, in the circuit simulation apparatus according to the first aspect, the control means controls the circuit simulation such that the digital circuit-simulating means performs the circuit simulation when a level of at least one of all the signals input to the digital circuit changes.

With this configuration, it is unnecessary to detect input signals that influence the output from and the internal state of the digital circuit, and therefore this configuration can achieve simplification of the configuration of the apparatus.

The present invention also provides a method of simulating an operation of an analog-digital hybrid circuit having an analog circuit and a digital circuit, comprising the steps of: simulating the analog circuit; simulating the digital circuit; and controlling timing of executing the step of simulating the digital circuit according to change of a level of at least one of a predetermined signal that is input to the analog circuit and a predetermined signal that is input to the digital circuit.

The present invention further provides a computer-executable circuit simulation program for executing a simulation of an operation of an analog-digital hybrid circuit having an analog circuit and a digital circuit, the simulation comprising the steps of: simulating the analog circuit; simulating the digital circuit; and controlling timing of executing the step of simulating the digital circuit according to change of a level of at least one of a predetermined signal that is input to the analog circuit and a predetermined signal that is input to the digital circuit.

The present invention also provides a storage media comprising: a computer-executable simulation program stored in the storage media for simulating an operation of an analog-digital hybrid circuit having an analog circuit and a digital circuit, the simulation program for executing the steps including; simulating the analog circuit; simulating the digital circuit; and controlling timing of executing the step of simulating the digital circuit according to change of a level of at least one of a predetermined signal that is input to the analog circuit and a predetermined signal that is input to the digital circuit.

According to these aspects of the invention, execution timing of the simulation for the digital circuit is controlled according to change of the input signal that influences changes in the levels of signals output from the digital circuit and the internal signals. As a result, the simulation for the analog-digital hybrid circuit can be performed at high speeds by considerably reducing the amount of computation or the like required for the simulation for the digital circuit, and appropriate results of the simulation can be obtained.

### BRIEF DESCRIPTION OF THE DRAWINGS

FIG. 1 is a block diagram showing the principal portion of a circuit simulation apparatus according to one embodiment of the present invention.

FIG. 2 is a flowchart showing the operation of the circuit simulation apparatus.

FIG. 3 is a block diagram showing an example of a timing recovery loop circuit (analog-digital hybrid circuit) that is simulated by the circuit simulation apparatus.

FIG. 4 is a block diagram showing another example of the digital circuit that is simulated by the circuit simulation apparatus.

FIG. 5 is a timing chart showing an example of the operation of the digital circuit.

FIG. 6 is a timing chart showing another example of the operation of the digital circuit.

FIG. 7 is a flowchart showing a control operation for simulation timing when an operation of the digital circuit illustrated in FIG. 4 is simulated.

FIG. 8 is a block diagram showing further another example of the digital circuit that is simulated by the circuit simulation apparatus.

FIG. 9 is a flowchart showing the control operation for simulation timing when an operation of the digital circuit illustrated in FIG. 8 is simulated.

FIG. 10 is a block diagram showing the principal portion of a circuit simulation apparatus according to one variation of the present invention.

FIG. 11 is a block diagram showing the principal portion of a circuit simulation apparatus according to another variation of the present invention.

FIG. 12 is a block diagram showing the principal portion of a circuit simulation apparatus according to further another variation of the present invention.

FIG. 13 is a block diagram showing the principal portion of a circuit simulation apparatus according to yet another variation of the present invention.

### DETAILED DESCRIPTION OF THE INVENTION

Hereinbelow, preferred embodiments of the present invention are described with reference to the drawings.

Configuration of Simulation Apparatus

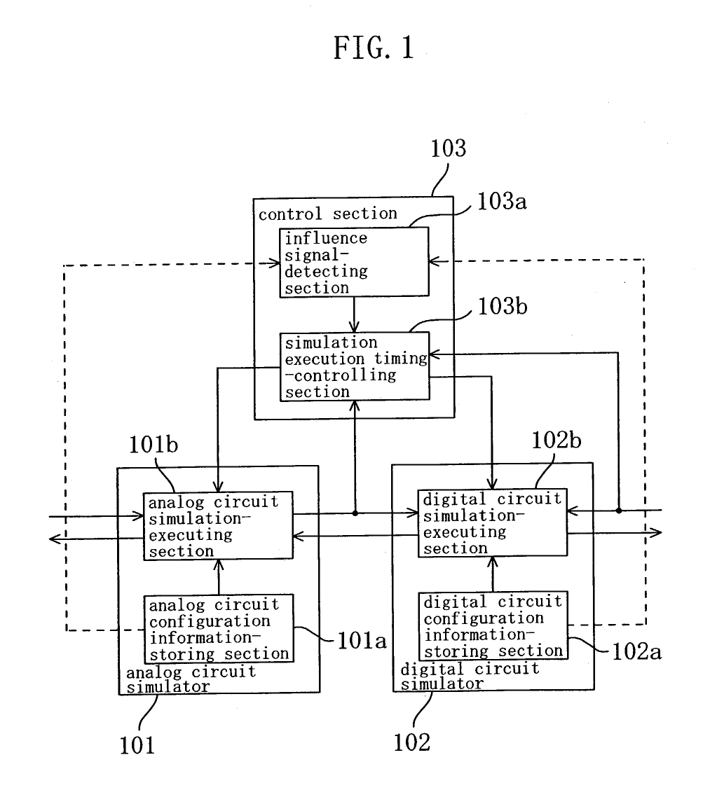

FIG. 1 is a block diagram showing the configuration of the principle portion of a circuit simulation apparatus for simulating an operation of an analog-digital hybrid circuit according to one embodiment of the present invention. As shown in the figure, the circuit simulation apparatus comprises an analog circuit simulator 101, a digital circuit simulator 102, and a control section 103.

The analog circuit simulator 101 has an analog circuit configuration information-storing section 101a and an analog circuit simulation-executing section 101b. The analog circuit configuration information-storing section 101a is configured to store circuit configuration information that indicates the configuration of an analog circuit whose circuit operation is to be simulated. The circuit configuration information includes, for example, data representing the characteristics of various elements that constitute the analog circuit and a net list representing the connections between those elements. The analog circuit simulation-executing section 101b simulates an operation of the analog circuit based on the circuit configuration information stored in the analog circuit configuration information-storing section 101a and the signal information indicating the levels of a signal that is input from outside of the hybrid circuit to the analog circuit (outside-analog circuit input signal) and a signal that is input from the digital circuit to the analog circuit (digital circuit-analog circuit input signal), and it generates signal information indicating the level of an output signal to outside of the hybrid circuit and to the digital circuit.

Likewise, the digital circuit simulator 102 has a digital circuit configuration information-storing section 102a and a digital circuit simulation-executing section 102b. Specifically, the digital circuit configuration information-storing section 102a is configured to store information such as a net list representing the configuration of a digital circuit whose circuit operation is to be simulated. The digital circuit simulation-executing section 102b simulates an operation of the digital circuit based on the circuit configuration information stored in the digital circuit configuration information-storing section 102a and signal information indicating the levels of a signal that is input from outside of the hybrid circuit to the digital circuit (outside-digital circuit input signal) and a signal that is input from the analog circuit to the digital circuit (analog circuit-digital circuit input signal), and it generates signal information indicating the levels of output signals that are output to outside of the hybrid circuit and to the analog circuit.

The control section 103 has an influence signal-detecting section 103a and a simulation execution-timing control section 103b. Based on the circuit configuration information stored in the analog circuit configuration information-storing section 101a and the digital circuit configuration information-storing section 102a, the influence signal-detecting section 103a detects which of the outside-digital circuit input signal and the analog circuit-digital circuit input signal is the signal that influences change in the level of the signal output from the digital circuit, that is, which signal is the signal for determining whether the simulation for the digital circuit is to be performed or not, prior to the simulation operation. The simulation execution timing-control section 103b controls the timing of executing the simulations performed by the simulators 101 and 102. More specifically, for the analog circuit simulator 101, it controls the simulator to simulate the operation for each cycle time Δt. On the other hand, for the digital circuit simulator 102, it monitors the signal level of the outside-digital circuit input signal and/or the analog circuit-digital circuit input signal that has/have been detected by the influence signal-detecting section 103a, and based on the change of the signal level, it makes the digital circuit simulator 102 simulate an operation of the digital circuit.

The circuit simulation apparatus as described above can be configured by, for example, a computer, an analog circuit simulation program, a digital circuit simulation program, and a simulation operation-controlling program, although these examples are given for illustrative purposes only

Simulation Operation

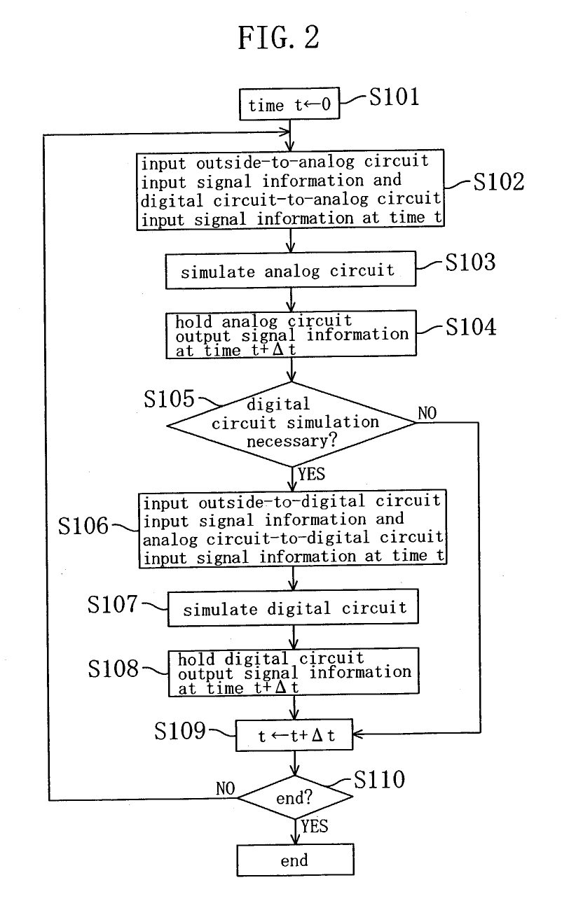

The operation of the circuit simulation apparatus configured as described above is described with reference to the flowchart shown in FIG. 2.

(S101) First, a variable t that indicates the time held in the control section 103 is set as t=0.

(S102) Signal information that indicates the levels of the outside-analog circuit input signal and the digital circuit-analog circuit input signal at time t is input to the analog circuit simulator 101.

(S103) Under control from the control section 103, the analog circuit simulator 101 performs a simulation of an operation of the analog circuit based on the foregoing signal information and the predetermined analog circuit configuration information.

(S104) As a result of the foregoing simulation, signal information is generated that represents the levels of the signals that are output from the analog circuit to outside of the hybrid circuit and to the digital circuit and the levels of the signals of various portions in the analog circuit. The signal information is held in a holding section, which is not shown in the figure, as signal information for time t+Δt.

(S105) The control section 103 analyzes the signal information that indicates the levels of the outside-digital circuit input signal and the analog circuit-digital circuit input signal, and it determines whether the signal information satisfies a predetermined condition or not, that is, whether a simulation for the digital circuit is necessary or not. The predetermined condition will be later explained in detail.

(S106) When the simulation for the digital circuit is determined to be necessary at (S105), the signal information that indicates the levels of the outside-digital circuit input signal and the analog circuit-digital circuit input signal is input to the digital circuit simulator 102.

(S107) Under the control of the control section 103, the digital circuit simulator 102 carries out a simulation of an operation of the digital circuit based on the signal information and the predetermined digital circuit configuration information.

(S108) As a result of the foregoing simulation, signal information is generated that indicates the levels of signals output from the digital circuit to outside of the hybrid circuit and to the analog circuit and the levels of signals of various portions inside the digital circuits, and the signal information is stored as signal information at time t+Δt in a holding section, which is not shown in the figure.

(S109) After the simulation for the digital circuit has been carried out in (S106) to (S108) and when it is determined that the simulation for the digital circuit is unnecessary in the foregoing (S105), the variable t that indicates the time to be held inside the control section 103 is updated as t=t+Δt.

(S110) If the time indicated by the variable t is later than a predetermined time, the simulation for the whole circuit is ended; if not, the steps that follow the foregoing (S102) are repeated.

Specific Example of Simulation Operation

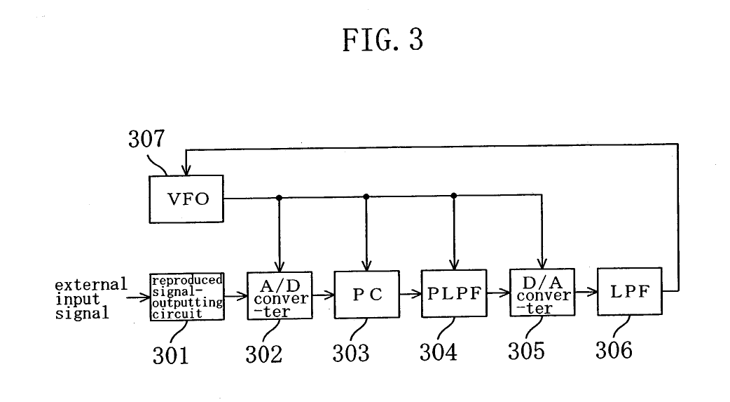

Next, control of execution timing for the simulation for the digital circuit is described taking a simulation for a timing recovery loop circuit illustrated in FIG. 3 as an example. In this example, a change in the level of a clock signal is a necessary condition for performing the simulation for the digital circuit.

The timing recovery loop circuit is, for example, for extracting a clock signal from a signal read from an optical disk, and it comprises a reproduced signal-outputting circuit 301, an A/D (analog to digital) converter 302, a PC (phase comparator) 303, a PLPF (phase loop filter) 304, a D/A (digital to analog) converter 305, a LPF (low pass filter) 306, and a VFO (variable frequency oscillator) 307.

The reproduced signal-outputting circuit 301 outputs an analog reproduced signal reproduced from a signal that has been read from an optical disk (external input signal).

The A/D converter converts the reproduced signal into a digital signal.

The PC 303 outputs a value corresponding to the phase difference between the phase of the digital signal at a time at which the digital signal value becomes 0 (zero cross point) and the phase of the clock signal output from the VFO 307.

The PLPF 304 carries out a predetermined filtering process for the value corresponding to the phase difference.

The D/A converter 305 outputs an analog signal with a level corresponding to the value that has been subject to the filtering process.

The LPF 306 outputs a direct current component of the analog signal as a frequency control signal.

The VFO 307 generates a clock signal with a frequency corresponding to the frequency control signal; that is, for example, it generates a clock signal with a high frequency when the level of the frequency control signal is high, whereas it generates a clock signal with a low frequency when the level of the frequency control signal is low. It supplies the clock signal to the A/D converter 302, the PC 303, the PLPF 304, and the D/A converter 305 in addition to outputting the clock signal to outside of the timing recovery loop circuit.

With the feedback loop as described above, the level of the frequency control signal becomes high (and accordingly the frequency of the clock signal output from the VFO 307 becomes high) when the frequency of the clock signal output from the VFO 307 is low and/or the phase thereof is delayed; whereas the level of the frequency control signal becomes low (and accordingly the frequency of the clock signal output from the VFO 307 becomes low) when the frequency of the clock signal output from the VFO 307 is high and/or the phase thereof is advanced. Thus, a clock signal synchronized with the reproduced signal can be obtained.

When the simulation for the timing recovery loop circuit is carried out as described above, the operations of the reproduced signal-outputting circuit 301, the A/D converter 302, the D/A converter 305, the LPF 306, and the VFO 307, for example, are simulated by the analog circuit simulator 101, and the operations of the PC 303 and the PLPF 304 are simulated by the digital circuit simulator 102. In other words, the analog circuit simulator 101 and the digital circuit simulator 102 simulate the entire operations in the above-described timing recovery loop circuit. (It should be noted that the A/D converter 302 and the D/A converter 305 may be treated as digital circuits, or may be simulated by both of the simulators 101 and 102.)

Here, at least the PC 303 and the PLPF 304 operate in complete synchronization with the clock signal output from the VFO 370. In other words, the signals output from the PC 303 and the PLPF 304 change only at the positive edges (or the negative edges) of the clock signal, and they do not change during the rest of times. During the rest of times, therefore, even though the digital circuit simulator 102 does not perform the simulation, no adverse effects are caused on the result of the simulation for the analog-digital hybrid circuit. In view of this, from the signal information that is transferred from the analog circuit simulator 101 to the digital circuit simulator 102, the control section 103 extracts and analyzes the information representing the clock signal output from the VFO 307, and the control section 103 controls the digital circuit simulation 102 so as to perform the simulation only at the timing when clock edges occur (under the condition where clock edges occur). As a consequence, even if, for example, the frequency (phase) of the clock signal changes, the amount of computation in the digital circuit simulator 102 can be considerably reduced without causing any adverse effects on the result of the simulation for the analog-digital hybrid circuit, and therefore, the simulation for the whole timing recovery loop circuit can be performed at high speed.

Another Example of Signal Determining Whether Simulation for Digital Circuit is to be Performed or Not

The foregoing description has illustrated an example in which the execution timing of the simulation carried out by the digital circuit simulator 102 is controlled based on the clock signal input to the digital circuit simulator 102, in other words, an example in which the condition for making the digital circuit carry out the simulation is a change in the level of the clock signal. However, the invention is not limited thereto.

For example, it is possible to monitor changes in the levels of all the signals that are input to the digital circuit in order to perform the simulation for the digital circuit at any time when one of the levels of signals changes. In this case, it is necessary to check all the signals that are input to the digital circuit at each cycle time of the analog circuit simulation, but nevertheless, the time necessary for the simulation can be considerably reduced since if none of the signals changes, the simulation for the digital circuit is not carried out. Moreover, the configuration of the apparatus can be simplified because it is not necessary to detect a signal that influences the output from and the internal state of the digital circuit.

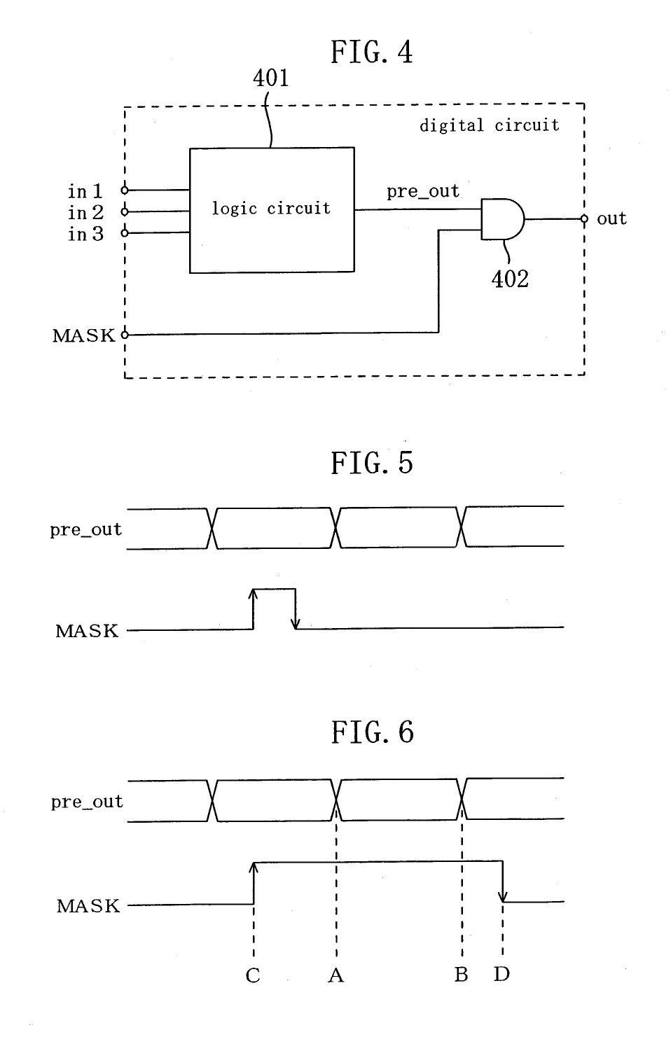

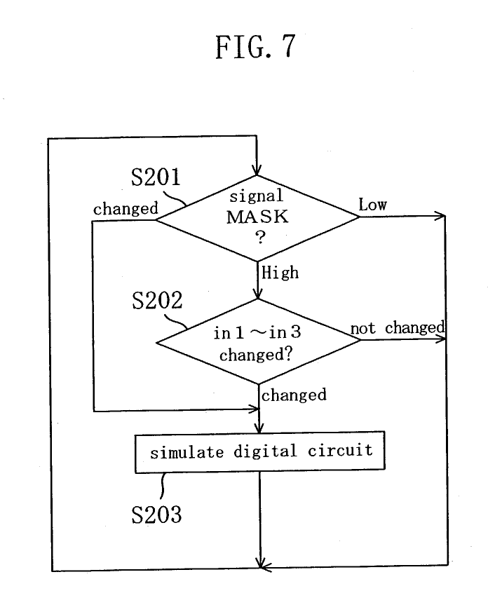

On the other hand, if the apparatus is configured to monitor only the signal that changes the level of a signal output from the digital circuit at the timing corresponding to the change of the level of the signal (for example, a mask signal or a gate signal that masks input and output signals), the time necessary for the simulation can be further reduced since the time required for the monitoring is reduced. Specifically, for example, assume the digital circuit has a configuration as shown in FIG. 4. In this digital circuit, a signal pre_out and a signal MASK are input to an AND circuit 402 based on input signals in1 to in3 that are input from outside of the analog-digital hybrid circuit or from the analog circuit. The digital circuit outputs an output signal out. In the case where the signal MASK becomes an H (high) level only during a period in which the level of the signal pre_out is constant in this circuit, as shown in FIG. 5, only the signal MASK is monitored so that the simulation for the digital circuit is carried out only at the timing of the rising edges and the falling edges of the signal MASK. Alternatively, the following process may be employed for the circuit as shown in FIG. 4 in the case where there is a possibility that the level of the signal pre_out changes according to the change of the levels of the input signals in1 to in3 during a period in which the signal MASK is at an H level. Specifically, the process is as follows; as shown in FIG. 7, which depicts the primary portion of the process, (S201) the level of the signal MASK is identified; (S202) then, the input signals in1 to in3 are monitored only when the level is at H; and (S203) the simulation for the digital circuit is carried out only when the levels of the input signals in1 to in3 change (time A and time B in FIG. 6) and when the level of the signal MASK changes in S201 (time C and time D in FIG. 6). Thus, the simulation for the digital circuit is performed only four times, at times A to D, regardless of the simulation cycle time for the analog circuit, and as a result, the time necessary for the simulation can be considerably reduced.

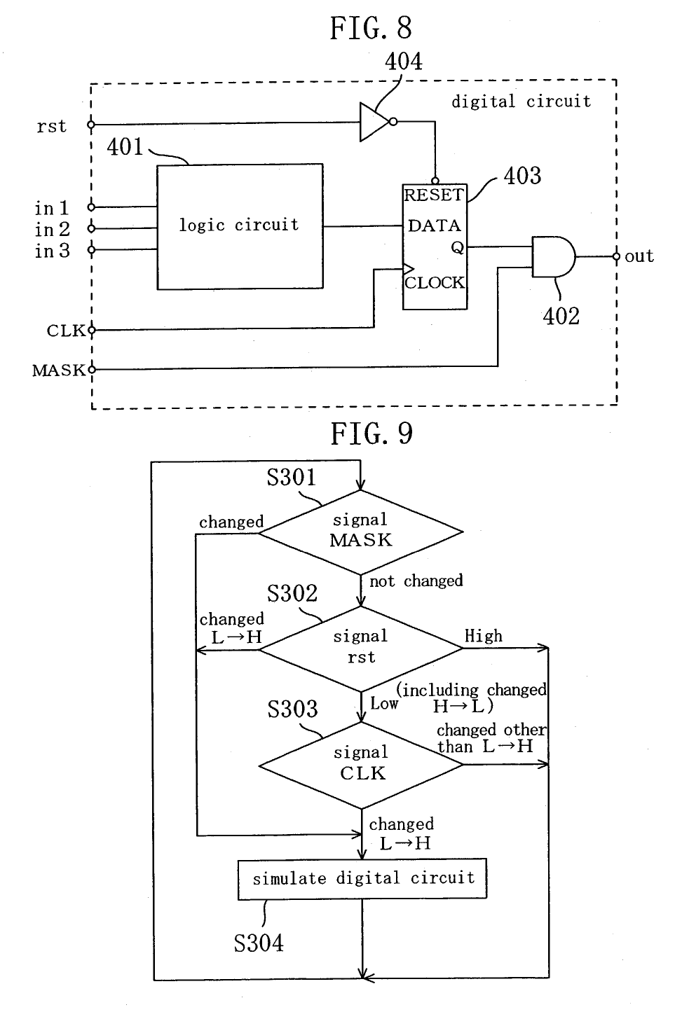

In addition, a configuration as shown in FIG. 8 may be employed in which a flip-flop circuit 403 is provided between the logic circuit 401 and the AND circuit 402 in the digital circuit. In this circuit, for example, when the digital circuit receives a clock signal CLK that controls the flip-flop circuit 403, or when the digital circuit receives an input reset signal rst that changes a reset signal RESET for controlling the flip-flop circuit 403, the simulation for the digital circuit may be achieved by monitoring the clock signal CLK, the input reset signal rst, and the signal MASK. Specifically, when the input reset signal rst changes into a H level during the period in which the signal MASK is at an L (low) level, the level of an output signal out does not change but the holding state of the flip-flop circuit 403 changes; accordingly, the level of the output signal that is output when the signal MASK becomes an H level next time. In view of this, a configuration as shown in FIG. 9, which depicts the primary portion of the process, may be employed. Specifically, the process is as follows; the level of the signal MASK is identified (S301); if the level of the signal MASK changes, the simulation for the digital circuit is performed (S304); if the level of the signal MASK does not change, the levels of the input reset signal rst and the clock signal CLK are identified (S302, S303); if the reset signal rst changes from an L level to an H level or if the input reset signal rst is at an L level and the clock signal CLK changes from an L level to an H level, the simulation for the digital circuit is performed. At other times, the simulation for the digital circuit does not need to be performed even if the levels of the input signals in1 to in3, and consequently, the simulation can be performed at high speed. In addition, when the digital circuit performs different operations depending on the sequence of the timing at which the level of a signal changes and the timing at which the level of another signal changes, such as in cases of sequential circuits, the simulation for the digital circuit may be performed at the timing at which the levels of the signals change. This also achieves similar effects.

When the timing of the simulation for a digital circuit is controlled according to an input signal that corresponds to the configuration of the digital circuit or the state of the change in the level of an input signal, as described above, the simulation for an analog-digital hybrid circuit can be reliably performed at high speed. In addition, when the simulation timing is controlled by a plurality of signal levels or combinations of the changes thereof, it is also possible to optimize the sequence of identifying the signal levels and the changes of the levels or the like. This makes it possible to further reduce the frequency of the identifying and to increase the speed of the simulation.

Detection of Signal that Controls Simulation Timing for Digital Circuit

The signal that constitutes a condition for determining whether the simulation for a digital circuit is to be performed or not, which is the signal whose level is to be monitored, is detected (identified) by, for example, the influence signal-detecting section 103a based on the circuit configuration information.

Specifically, the influence signal-detecting section 103a detects a signal that changes the level of the signal output from the digital circuit, a signal that changes the internal state of the digital circuit, or the like, as described above, by analyzing the circuit configuration information stored in the digital circuit configuration information-storing section 102a. More specifically, the influence signal-detecting section 103a refers to attribute information such as signal names for the internal signals and input/output signals of the analog circuit and the digital circuit, and, for example, if the name of a signal contains “clock” or the like, it detects the signal as the signal for the foregoing timing control. Alternatively, for example, by detecting a signal connected to a clock input terminal of an element whose element name contains “FF” (flip-flop) or the like, the signal for the timing control can be easily obtained. In addition, it is possible to detect the signal that has influence on the output signal from the digital circuit or the internal state thereof by analyzing the circuit configuration information in more detail. The method for the detection is, however, not limited to those described above. It is possible that the apparatus receive a designation of a signal from an operator or the like in advance and it monitor the change in the level of the designated signal. Moreover, it is possible to combine these detection techniques in order to monitor changes in the levels of detected signals.

Accordingly, the signal that controls the timing of the simulation for a digital circuit can be reliably obtained easily, and as a result, the frequency of the simulation for the digital circuit can be minimized to a bare minimum.

Variations

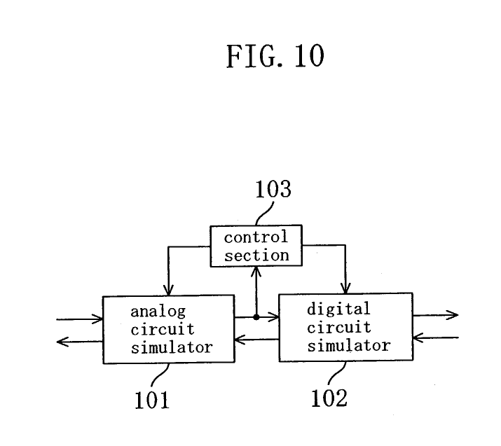

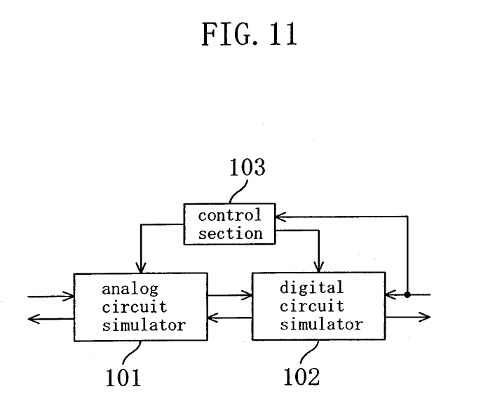

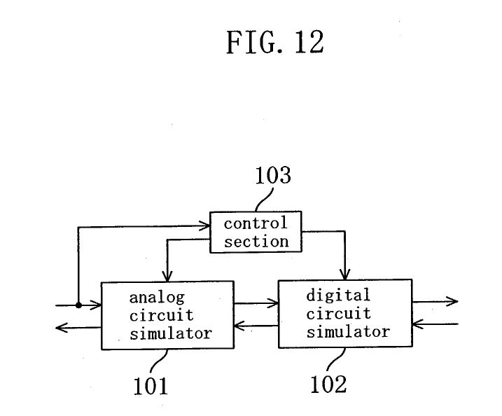

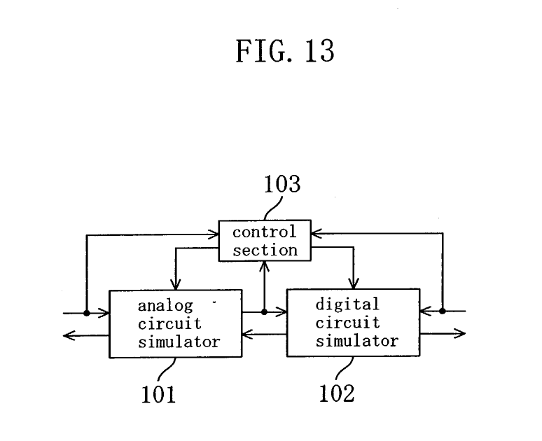

The control of the simulation timing is not limited to that performed based on both the signal input from outside of the analog-digital hybrid circuit to the digital circuit and the signal input from the analog circuit to digital circuit. It is possible that the control is performed based on either one of the signals, as shown in FIGS. 10 and 11. In addition, as shown in FIG. 12 it is also possible to use a signal input from outside of the analog-digital hybrid circuit to the analog circuit, or to use the signal input from outside of the analog-digital hybrid circuit to the analog circuit and either one of the signals input to the digital circuit. It is further possible to use the combination of all the signals, as shown in FIG. 13. The signal input to the analog circuit can be used for the following reason. When the signal input to the analog circuit is, for example, a signal that has been subject to a relatively simple process (such as a binarization with a Schimitt trigger or a comparator) in the analog circuit, there are cases where the timing at which the level of the signal input from the analog circuit to the digital circuit changes can be obtained based on the change in the level of the signal input to the analog circuit digital circuit.

It is not necessary that the whole digital circuit be simulated at the same timing. For example, it is possible that the digital circuit is divided into a plurality of blocks and the simulation is performed according to a signal that controls the simulation timing for each block.

As has been described thus far, according to the present invention, appropriate simulation results for analog-digital hybrid circuits can be obtained, and a high-speed simulation for analog-digital hybrid circuits can be performed by considerably reducing the simulation operation (the amount of computation) for digital circuits.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A circuit simulation apparatus for simulating an operation of an analog-digital hybrid circuit having an analog circuit and a digital circuit, comprising:
an analog circuit-simulating means for performing a simulation for the analog circuit;
a digital circuit-simulating means for performing a simulation for the digital circuit; and
a control means for controlling timing of executing the circuit simulation performed by the digital circuit-simulating means according to change of the level of at least one of a predetermined signal that is input to the analog circuit and a predetermined signal that is input to the digital circuit.

2. The circuit simulation apparatus according to claim 1, wherein the predetermined signal comprises a clock signal.

3. The circuit simulation apparatus according to claim 1, wherein the predetermined signal comprises a signal that changes, at timing corresponding to the change of the signal level of the signal, the level of a signal which is output from the digital circuit.

4. The circuit simulation apparatus according to claim 1, wherein the predetermined signal comprises at least one of a signal that controls a state-holding circuit in the digital circuit and a signal that changes the signal that controls a state-holding circuit in the digital circuit.

5. The circuit simulation apparatus according to claim 1, wherein the predetermined signal comprises a signal such that the digital circuit operates differently according to the sequence between change timing of the level of a signal and change timing of the level of another signal.

6. The circuit simulation apparatus according to claim 1, wherein the predetermined signal is designated in advance of the simulation.

7. The circuit simulation apparatus according to claim 1, further comprising:
a detecting means for detecting at least one of the predetermined signal that is input to the analog circuit and the predetermined signal that is input to the digital circuit;
wherein the control means controls the circuit simulation so that the circuit simulation performed by the digital circuit simulation means is executed when the predetermined signal level detected by the detecting means changes.

8. The circuit simulation apparatus according to claim 7, wherein the detecting means detects the predetermined signal based on attribute information of at least one of a signal input to the analog circuit and a signal input to the digital circuit, the signals being supplied to at least one of the analog circuit-simulating means and the digital circuit simulating means.

9. The circuit simulation apparatus according to claim 7, wherein the detecting means detects the predetermined signal by analyzing circuit configuration information representing the digital circuit, the circuit configuration information being given to the digital circuit-simulating means.

10. The circuit simulation apparatus according to claim 1, wherein the control means controls the circuit simulation such that the digital circuit-simulating means performs the circuit simulation when a level of at least one of all the signals input to the digital circuit changes.

11. A method of simulating an operation of an analog-digital hybrid circuit having an analog circuit and a digital circuit, comprising the steps of:
simulating the analog circuit;
simulating the digital circuit; and
controlling timing of executing the step of simulating the digital circuit according to change of a level of at least one of a predetermined signal that is input to the analog circuit and a predetermined signal that is input to the digital circuit.

12. A computer-executable circuit simulation program for executing a simulation of an operation of an analog-digital hybrid circuit having an analog circuit and a digital circuit, the simulation comprising the steps of:
simulating the analog circuit;
simulating the digital circuit; and
controlling timing of executing the step of simulating the digital circuit according to change of a level of at least one of a predetermined signal that is input to the analog circuit and a predetermined signal that is input to the digital circuit.

13. A storage media comprising:
a computer-executable simulation program stored in the storage media for simulating an operation of an analog-digital hybrid circuit having an analog circuit and a digital circuit, the simulation program for executing the steps including;
simulating the analog circuit;
simulating the digital circuit; and
controlling timing of executing the step of simulating the digital circuit according to change of a level of at least one of a predetermined signal that is input to the analog circuit and a predetermined signal that is input to the digital circuit.
